(19) United States
(12) Patent Application Publication
(10) Pub. No.: US 2023/0401098 A1
(43) Pub. Date: Dec. 14, 2023

(54) PROVISIONAL RESOURCE SCHEDULING IN A CLOUD COMPUTING ENVIRONMENT

(71) Applicant: International Business Machines Corporation, Armonk, NY (US)

(72) Inventors: Asser Nasreldin Tantawi, Somers, NY (US); Ming-Hung Chen, Mount Kisco, NY (US); Pavlos Maniotis, White Plains, NY (US); Claudia Misale, White Plains, NY (US); Laurent Schares, Pleasantville, NY (US); Seetharami R. Seelam, Chappaqua, NY (US); Hao Yu, Chappaqua, NY (US)

(21) Appl. No.: 18/062,182

(22) Filed: Dec. 6, 2022

(30) Foreign Application Priority Data
Jun. 8, 2022 (GR) 20220100640

(51) Int. Cl. G06F 9/50

(52) U.S. Cl. CPC G06F 9/5033

(57) ABSTRACT

Approaches presented herein enable provisional scheduling of resources in a cloud computing environment. More specifically, a first group request to host an application is obtained. This first group request includes one or more virtual units, which each have one or more topological constraints. One or more resources are scheduled for each of the virtual units. This scheduling includes provisionally allocating the resources to each of the virtual units according to the topological constraints. Each resource comprises a respective weight. In response to obtaining a second group request, the resources are provisionally re-allocated to one or more virtual units of the second group request according to one or more topological constraints of the second group request and the respective weight of each of the resources. This re-allocating minimizes a summation of each respective weight of the resources. A new respective weight is then assigned to each of the resources.

### TECHNICAL FIELD

The present invention relates generally to provisional resource scheduling in a cloud computing environment and, more specifically, to processing a group request that includes virtual units to host an application, and provisionally allocating resources to the virtual units.

### BACKGROUND

A networked computing environment (e.g., cloud computing environment) is an enhancement to the predecessor grid environment, whereby multiple grids and other computation resources may be further enhanced by one or more additional abstraction layers (e.g., a cloud layer), thus making disparate devices appear to an end-consumer as a single pool of seamless resources. These resources may include such things as physical or logical computing engines, servers and devices, device memory, and storage devices, among others.

Providers in the networked computing environment often deliver services online via a remote server, which can be accessed via a web service and/or software, such as a web browser. Individual clients can run virtual machines (VMs) that utilize these services and store the data in the networked computing environment. This can allow a single physical server to host and/or run many VMs simultaneously.

Approaches to computing resource scheduling and allocation in a cloud computing environment have included reserving resources in advance of their need which has led to resource underutilization. Another approach has been just-in-time allocation of resources which may lead to a potential failure to satisfy group request constraints.

### SUMMARY

According to an embodiment of the present invention, resources are provisionally scheduled in a cloud computing environment. More specifically, a first group request to host an application is obtained. This first group request includes one or more virtual units, which each have one or more topological constraints. One or more resources are scheduled for each of the virtual units. This scheduling includes provisionally allocating the resources to each of the virtual units according to the topological constraints. Each resource comprises a respective weight. In response to obtaining a second group request, the resources are provisionally re-allocated to one or more virtual units of the second group request according to one or more topological constraints of the second group request and the respective weight of each of the resources. This re-allocating minimizes a summation of each respective weight of the resources. A new respective weight is then assigned to each of the resources.

One aspect of the present invention includes a method for provisionally scheduling one or more resources in a cloud computing environment, comprising: obtaining a first group request to host an application, wherein the first group request comprises one or more virtual units, and wherein each of the one or more virtual units comprise one or more topological constraints; scheduling one or more resources for each of the one or more virtual units, wherein the scheduling comprises provisionally allocating the one or more resources to each of the one or more virtual units according to the one or more topological constraints, and wherein each of the one or more resources comprises a respective weight; responsive to obtaining a second group request, provisionally re-allocating the one or more resources to one or more virtual units of the second group request according to one or more topological constraints of the second group request and the respective weight of each of the one or more resources, wherein the re-allocating minimizes a summation of each respective weight of the one or more resources; and assigning a new respective weight to each of the one or more resources.

Another aspect of the present invention includes a computer system for provisionally scheduling one or more resources in a cloud computing environment, the computer system comprising: a memory medium comprising program instructions; a bus coupled to the memory medium; and a processor, for executing the program instructions, coupled to provisional scheduler engine via the bus that when executing the program instructions causes the system to: obtain a first group request to host an application, wherein the first group request comprises one or more virtual units, and wherein each of the one or more virtual units comprise one or more topological constraints; schedule one or more resources for each of the one or more virtual units, wherein the scheduling comprises provisionally allocating the one or more resources to each of the one or more virtual units according to the one or more topological constraints, and wherein each of the one or more resources comprises a respective weight; responsive to obtaining a second group request, provisionally re-allocate the one or more resources to one or more virtual units of the second group request according to one or more topological constraints of the second group request and the respective weight of each of the one or more resources, wherein the re-allocating minimizes a summation of each respective weight of the one or more resources; and assign a new respective weight to each of the one or more resources.

Yet another aspect of the present invention includes a computer program product for provisionally scheduling one or more resources in a cloud computing environment, the computer program product comprising a computer readable hardware storage device, and program instructions stored on the computer readable hardware storage device, to: obtain a first group request to host an application, wherein the first group request comprises one or more virtual units, and wherein each of the one or more virtual units comprise one or more topological constraints; schedule one or more resources for each of the one or more virtual units, wherein the scheduling comprises provisionally allocating the one or more resources to each of the one or more virtual units according to the one or more topological constraints, and wherein each of the one or more resources comprises a respective weight; responsive to obtaining a second group request, provisionally re-allocate the one or more resources to one or more virtual units of the second group request according to one or more topological constraints of the second group request and the respective weight of each of the one or more resources, wherein the re-allocating minimizes a summation of each respective weight of the one or more resources; and assign a new respective weight to each of the one or more resources.

Still yet, any of the components of the present invention could be deployed, managed, serviced, etc., by a service provider who offers to implement passive monitoring in a computer system.

Embodiments of the present invention also provide related systems, methods, and/or program products.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an architecture in which the invention may be implemented according to illustrative embodiments of the present invention.

FIG. 2 depicts a cloud computing environment according to illustrative embodiments of the present invention.

FIG. 3 depicts abstraction model layers according to illustrative embodiments of the present invention of the present invention.

FIG. 4 depicts a system diagram describing the functionality discussed herein according to illustrative embodiments of the present invention.

FIG. 5 depicts topological constraints that may pertain to resources according to illustrative embodiments.

FIG. 6 depicts factors that may be used in determining resource weights according to illustrative embodiments.

FIGS. 7A-7M depicts state diagrams illustrating a provisional scheduling process according to illustrative embodiments.

FIG. 8 depicts a process flowchart for a provisional scheduling process according to illustrative embodiments.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Illustrative embodiments will now be described more fully herein with reference to the accompanying drawings, in which illustrative embodiments are shown. It will be appreciated that this disclosure may be embodied in many different forms and should not be construed as limited to the illustrative embodiments set forth herein. Rather, these embodiments are provided so that this disclosure will be thorough and complete and will fully convey the scope of this disclosure to those skilled in the art.

Furthermore, the terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. Furthermore, similar elements in different figures may be assigned similar element numbers. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless specifically stated otherwise, it may be appreciated that terms such as “processing,” “detecting,” “determining,” “evaluating,” “receiving,” or the like, refer to the action and/or processes of a computer or computing system, or similar electronic data center device, that manipulates and/or transforms data represented as physical quantities (e.g., electronic) within the computing system's registers and/or memories into other data similarly represented as physical quantities within the computing system's memories, registers or other such information storage, transmission or viewing devices. The embodiments are not limited in this context.

As stated above, embodiments described herein provide for provisional scheduling of resources in a cloud computing environment. More specifically, a first group request to host an application is obtained. This first group request includes one or more virtual units, which each have one or more topological constraints. One or more resources are scheduled for each of the virtual units. This scheduling includes provisionally allocating the resources to each of the virtual units according to the topological constraints. Each resource comprises a respective weight. In response to obtaining a second group request, the resources are provisionally re-allocated to one or more virtual units of the second group request according to one or more topological constraints of the second group request and the respective weight of each of the resources. This re-allocating minimizes a summation of each respective weight of the resources. A new respective weight is then assigned to each of the resources.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed, automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

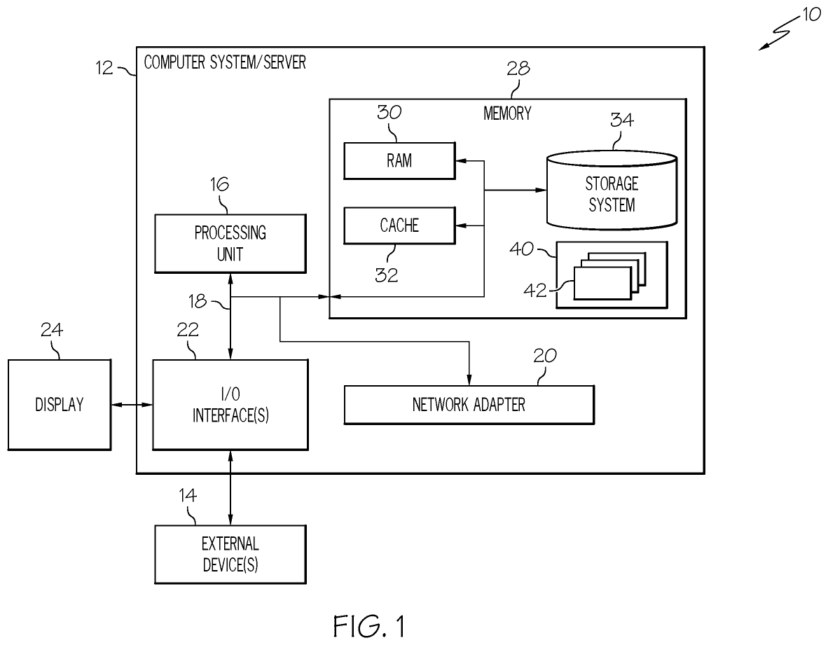

Referring now to FIG. 1, a schematic of an example of a cloud computing node for provisionally scheduling resources in a cloud computing environment will be shown and described. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10, there is a computer system/server 12, which is operational with numerous other computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 is intended to represent any type of computer system/server that may be implemented in deploying/realizing the teachings recited herein. Computer system/server 12 may be described in the general context of computer system/server executable instructions, such as program modules, being executed by a computer system. Generally, program modules may include routines, programs, objects, components, logic, data structures, and so on, that perform particular tasks or implement particular abstract data types. In this particular example, computer system/server 12 may be practiced in distributed cloud computing environments where tasks are performed by remote processing devices that are linked through a communications network. In a distributed cloud computing environment, program modules may be located in both local and remote computer system storage media including memory storage devices.

Computer system/server 12 in cloud computing node 10 is shown in the form of a computing device. The components of computer system/server 12 may include, but are not limited to, one or more processors or processing units 16, a system memory 28, and a bus 18 that couples various system components including system memory 28 to processing unit 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Processing unit 16 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 16 collects and routes signals representing inputs and outputs between external devices 14 and input devices (not shown). The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 16 executes computer program code, such as program code for provisionally scheduling resources in a cloud computing environment, which is stored in memory 28, storage system 34, and/or program/utility 40. While executing computer program code, processing unit 16 can read and/or write data to/from memory 28, storage system 34, and program/utility 40.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media, (e.g., VCRs, DVRs, RAID arrays, USB hard drives, optical disk recorders, flash storage devices, and/or any other data processing and storage elements for storing and/or processing data). By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and/or an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation. Memory 28 may also have an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

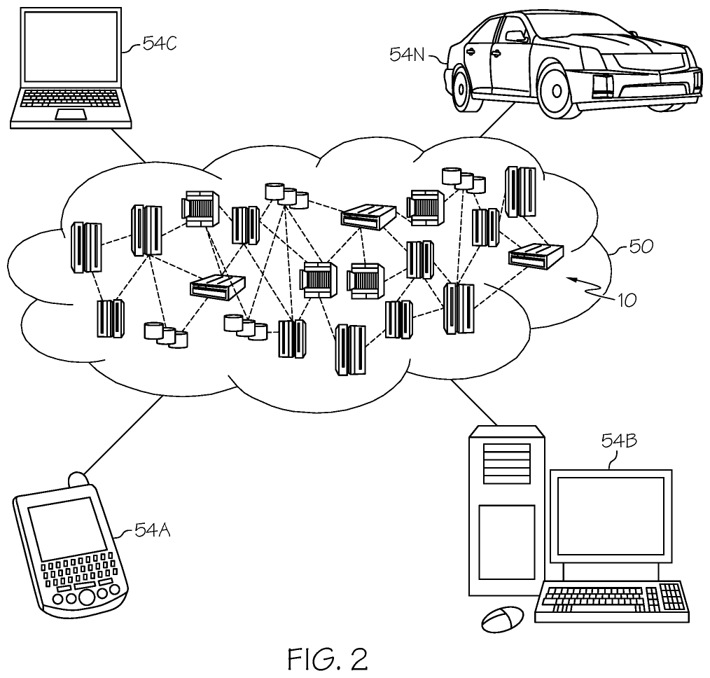

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

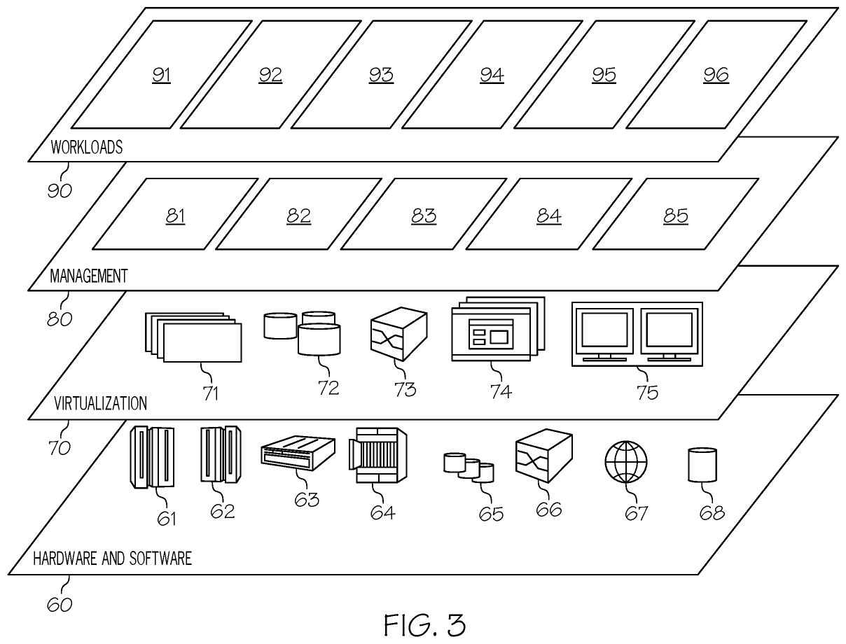

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91, software development and lifecycle management 92, virtual classroom education delivery 93, data analytics processing 94, transaction processing 95, and resource provisional scheduling 96. As mentioned above, all of the foregoing examples described with respect to FIG. 3 are illustrative only, and the invention is not limited to these examples.

It is understood that all functions of the present invention as described herein typically may be performed by provisional resource scheduling 96 functionality (of workload layer 90), which can be tangibly embodied as program modules 42, having program code, of program/utility 40 (FIG. 1). However, this need not be the case. Rather, the functionality recited herein could be carried out/implemented and/or enabled by any of the layers shown in FIG. 3.

It is reiterated that although this disclosure includes a detailed description on cloud computing, implementation of the teachings recited herein are not limited to a cloud computing environment. Rather, some embodiments of the present invention are intended to be implemented with any type of networked computing environment now known or later developed.

The inventors of the present invention have found that a static optimized placement policy for computing workloads in a cloud environment may be inefficient. The inventors have also found that allocating resources to an application at the time of a group request in accordance with group constraints may lead to potentially wasted resources if associated virtual unit requests are spaced in time. The inventors have further found that allocating resources to a virtual unit request at the time a group request arrives may lead to potentially failing to satisfy group constraints.

Accordingly, the inventors of the present invention have developed a system that provisionally schedules resources in a cloud computing environment when a group request to host an application is received. The group request may include virtual units, and each of the virtual units may include topological constraints. Computing resources may be provisionally allocated to the virtual units (i.e., allocations may be “penciled-in”) according to the topological constraints.

Furthermore, embodiments of the present invention offer several advantages, including but not limited to increasing the efficiency and timeliness of provisioning resources for virtual units, lowering overall execution times of applications, and lowering network bandwidth and power consumption during execution of applications, as compared with other resource scheduling and provisioning systems.

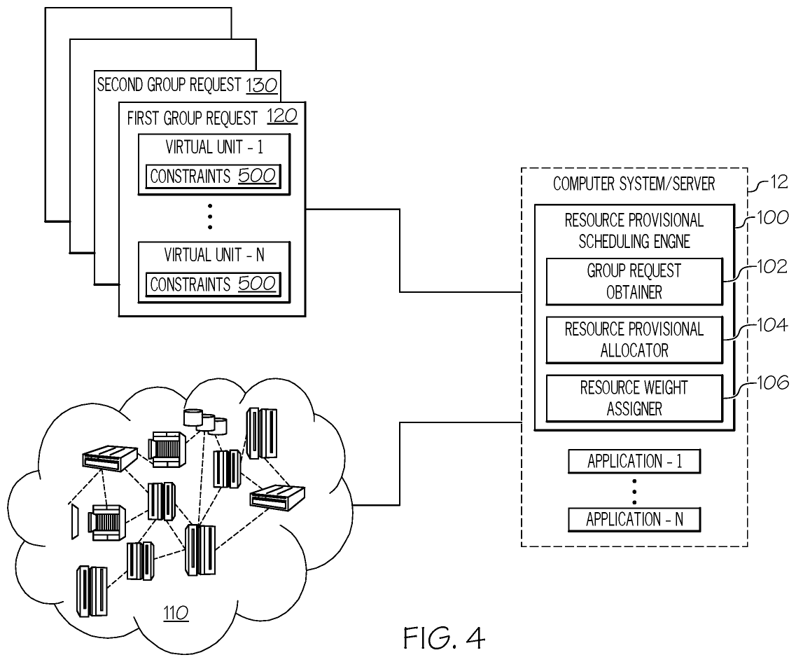

Referring now to FIG. 4, a system diagram describing the functionality discussed herein according to an embodiment of the present invention is shown. A stand-alone computer system/server 12 is shown in FIG. 4 for illustrative purposes only. In the event the teachings recited herein are practiced in a networked computing environment, each client need not have a resource provisional scheduling engine 100 (hereinafter “system 100”). Rather, all or part of system 100 could be loaded on a server or server-capable device that communicates (e.g., wirelessly) with the clients to provide for provisionally scheduling resources in a cloud computing environment. Regardless, as depicted, system 100 is shown within computer system/server 12. In general, system 100 can be implemented as program/utility 40 on computer system 12 of FIG. 1 and can enable the functions recited herein.

Among other functions, system 100 can provisionally schedule resources in a networked or cloud computing environment. To accomplish this, system 100 can include a set of components (e.g., program modules 42 of FIG. 1) for carrying out embodiments of the present invention. These components can include, but are not limited to, group request obtainer 102, resource provisional allocator 104, and resource weight assigner 106.

Through computer system/server 12, system 100 can be in communication with cloud computing environment 110. Moreover, according to some embodiments of the present invention, system 100 can receive/obtain first group request 120. The execution of application-1 through application-n may be initiated by first group request 120 and/or other group requests. Application-1 through application-n may be executed on computer system/server 12, as shown in FIG. 4, or on any appropriately configured computing resource located in cloud computing environment 110.

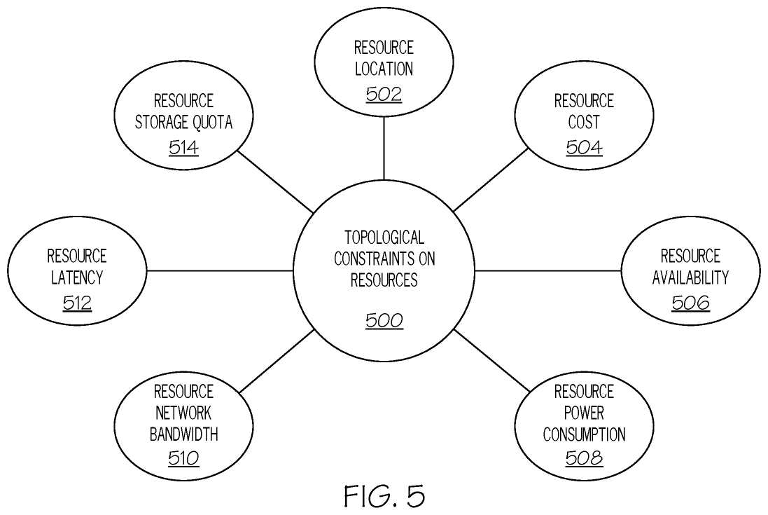

Resources may be provisionally scheduled by obtaining first group request 120 to host an application using group request obtainer 102. First group request 120 may comprise virtual unit-1 through virtual unit-n, and each of these virtual units may include topological constraints on resources 500 (described hereinbelow with respect to FIG. 5). Resources from cloud computing environment 110 may be scheduled for virtual unit-1 through virtual unit-n of first group request 120 by provisionally allocating resources to each virtual unit according to respective topological constraints 500 of each virtual unit by resource provisional allocator 104. Each of the resources can include a respective weight assigned by resource weight assigner 106.

In response to obtaining second group request 130, the resources from cloud computing environment 110 may be provisionally re-allocated to virtual units of second group request 130 according to topological constraints 500 of the second group request and the respective weight of each of the resources, such that the re-allocating minimizes a summation of each respective weight of the resources. A new respective weight may then be assigned to each of the resources. A respective weight of a resource may be calculated using the factors mentioned hereinabove in conjunction with heuristics, data mining, and machine learning methods that utilize historical data of resource weight assignments and/or workload placements.

In response to obtaining an invocation request for a virtual unit of virtual unit-1 through virtual unit-n, the resources that are provisionally allocated to the virtual unit may be actually allocated to the virtual unit. In response to a placement failure of first group request 120, resources that are allocated to the virtual units of first group request 120 may be re-allocated such that topological constraints 500 of first group request 120, second group request 130, and other group requests are met. Moreover, the resources that are allocated to an uninvoked first virtual unit may be provisionally re-allocated to a second virtual unit such that topological constraints 500 of group requests with which the first virtual unit and the second virtual unit are associated are met, and the re-allocation is performed periodically.

Referring now to FIG. 5 in connection with FIG. 4, examples of topological constraints on resources 500 are depicted. These examples of topological constraints 500 include resource location 502, resource cost 504, resource availability 506, resource power consumption 508, resource network bandwidth 510, resource latency 512, and resource storage quota 514.

Topological constraints 500 may be utilized to determine which resources meet the requirements set forth in selected ones of virtual unit-1 through virtual unit-n of first group request 120 (shown in FIG. 4). For example, confidential data may require processing in a particular geographic location which can be defined in resource location 502. Meeting a budgeted processing cost for an application could be defined in resource cost 504. Time sensitive processing could be restricted to a resource having an availability set forth in resource availability 506. Specifying a particular power consumption required by an application in resource power consumption 508 could be used to shift execution of an application to a lower power cost time of day or location. An application requiring significant network transmission of data could be restricted to resources having a bandwidth specified in resource network bandwidth 510. Real-time or end user-based applications, which require a high degree of responsiveness, could specify a maximum latency using resource latency 512. An application which requires frequent memory paging, or a large volume of data storage could have a minimum amount of available free storage specified using resource storage quota 514.

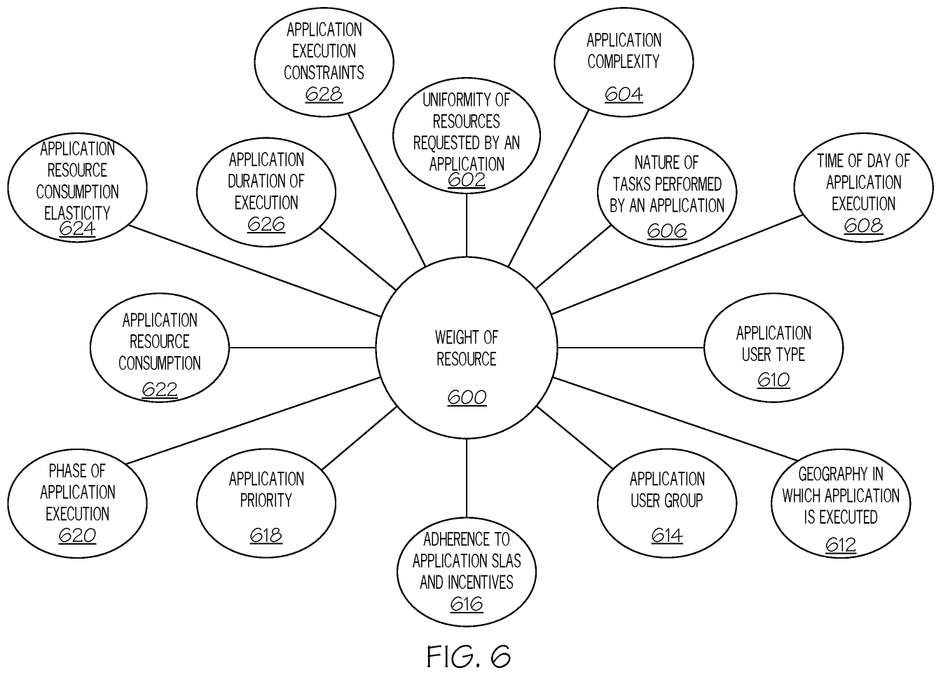

Referring now to FIG. 6 in connection with FIG. 4, examples of factors which may be utilized in calculating weight of resource 600 are depicted. These examples of factors which may be utilized in calculating weight of resource 600 include uniformity of resources requested by an application 602, application complexity 604, nature of tasks performed by an application 606, time of day of application execution 608, application user type 610, geography in which application is executed 612, application user group 614, adherence to application system level agreements (SLAs) and incentives 616, application priority 618, phase of application execution 620, application resource consumption 622, application resource consumption elasticity 624, application duration of execution 626, and application execution constraints 628.

As mentioned herein above with respect to FIG. 4, weight of resource 600 may be calculated using the factors mentioned herein above in conjunction with heuristics, data mining, and machine learning methods that utilize historical data of resource weight assignments and/or workload placements. A resource having an assigned respective weight of zero (0) indicates that the resource is available for allocation. A resource having an assigned respective weight between zero (0) and one (1) indicates that the resource is provisionally allocated. A resource having an assigned respective weight of one (1) indicates that the resource is already allocated. A first resource having a greater assigned respective weight than a second resource indicates that the first resource has a lower priority for re-allocation than the second resource. In general, resources that are required for an actual allocation will have a lower priority for re-allocation (i.e., are less likely to be re-allocated) than resources which are provisionally allocated.

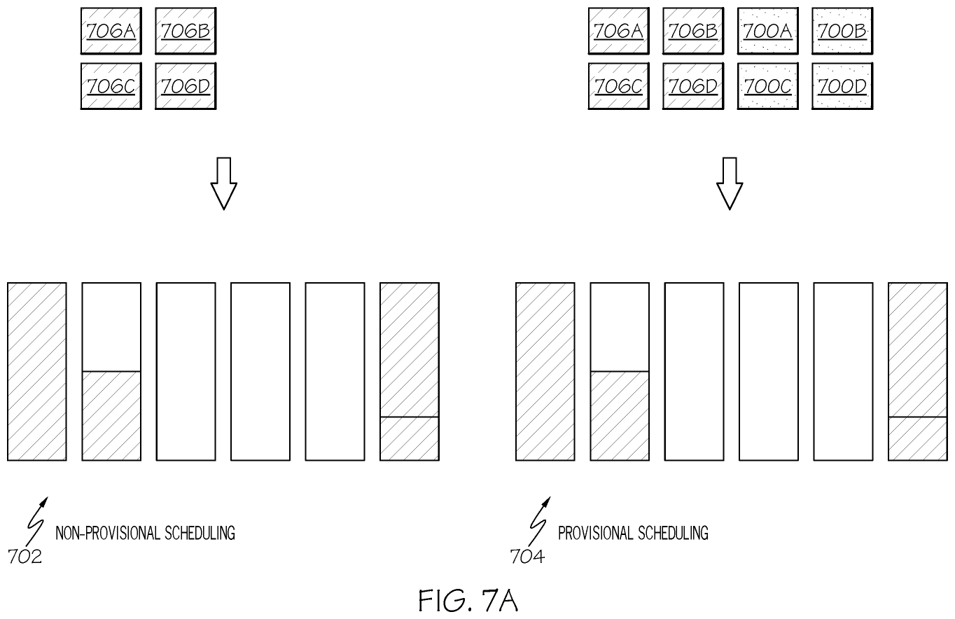

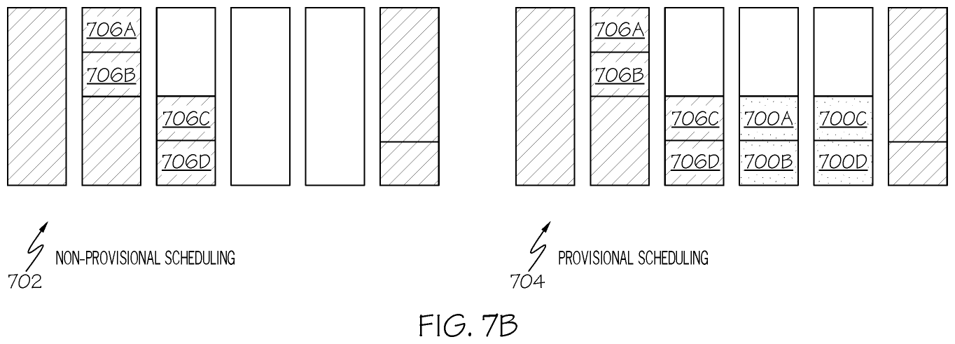

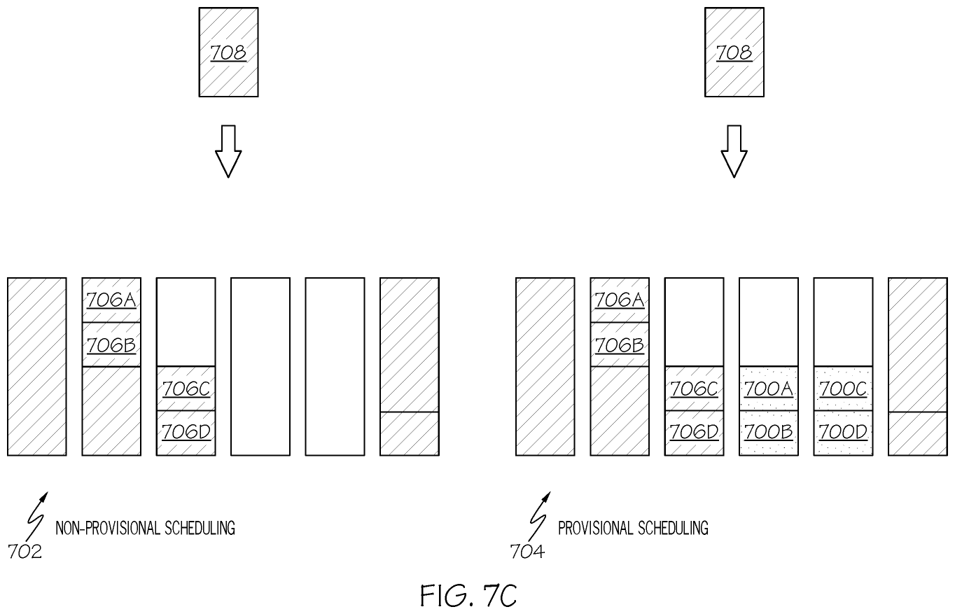

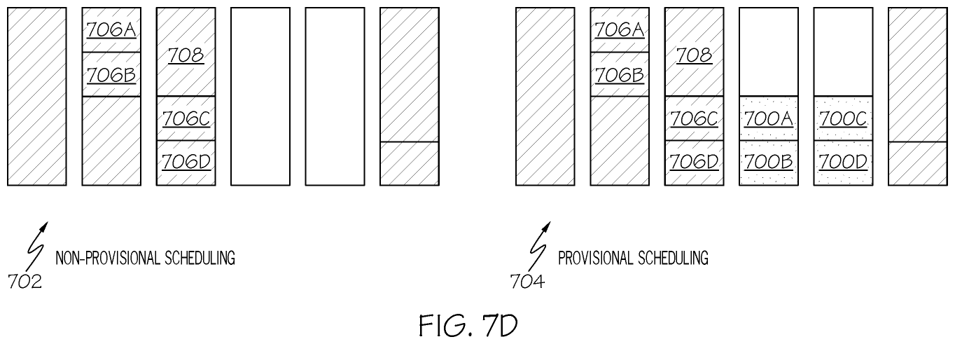

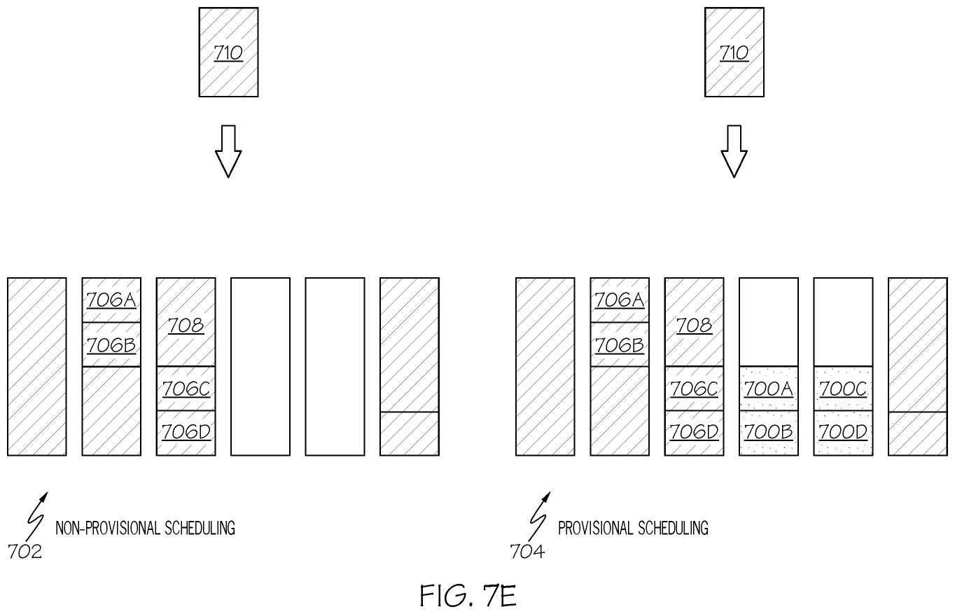

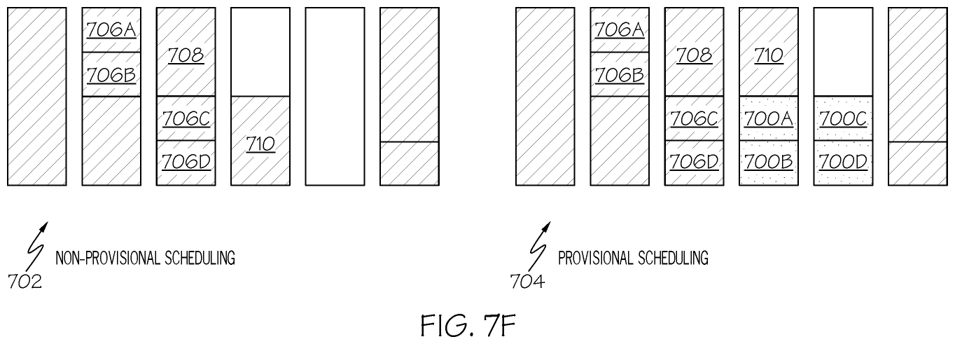

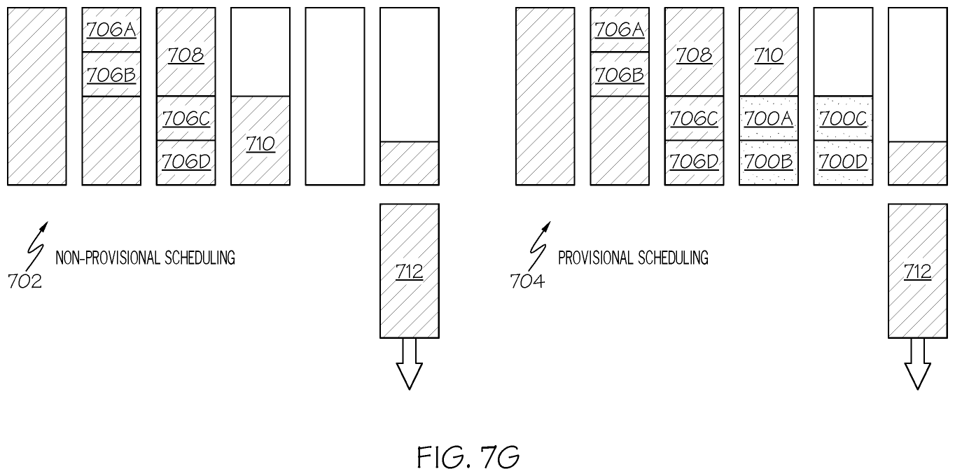

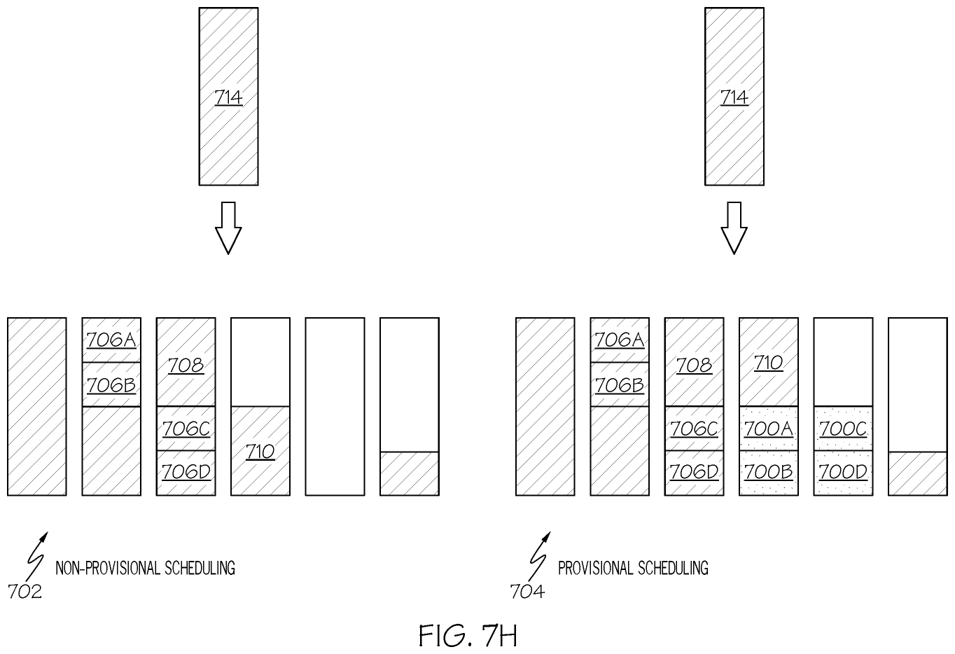

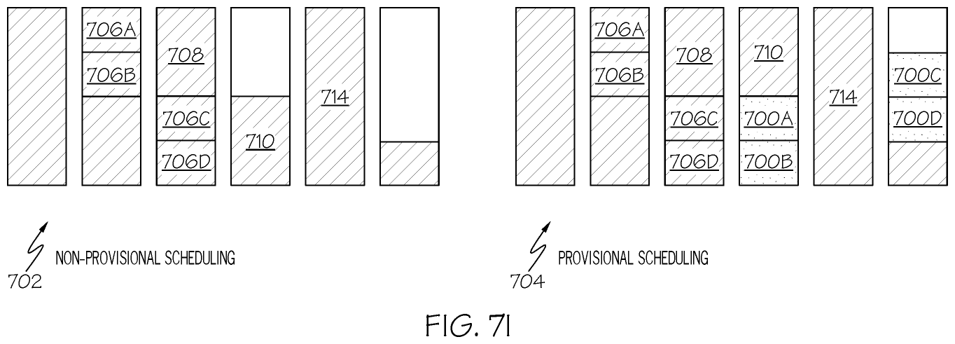

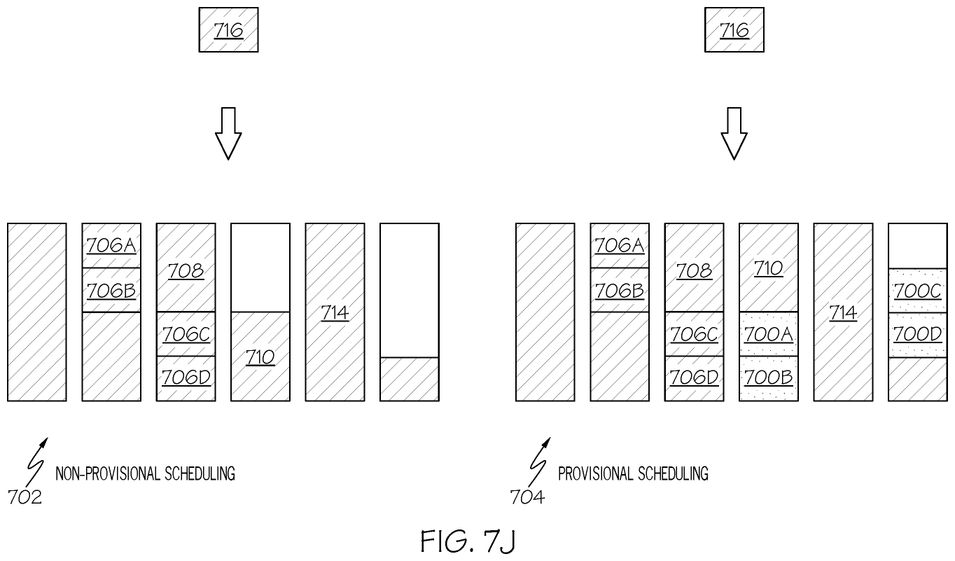

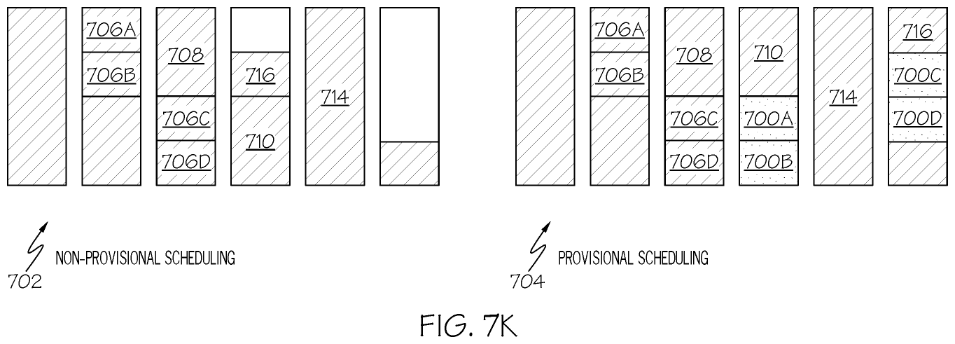

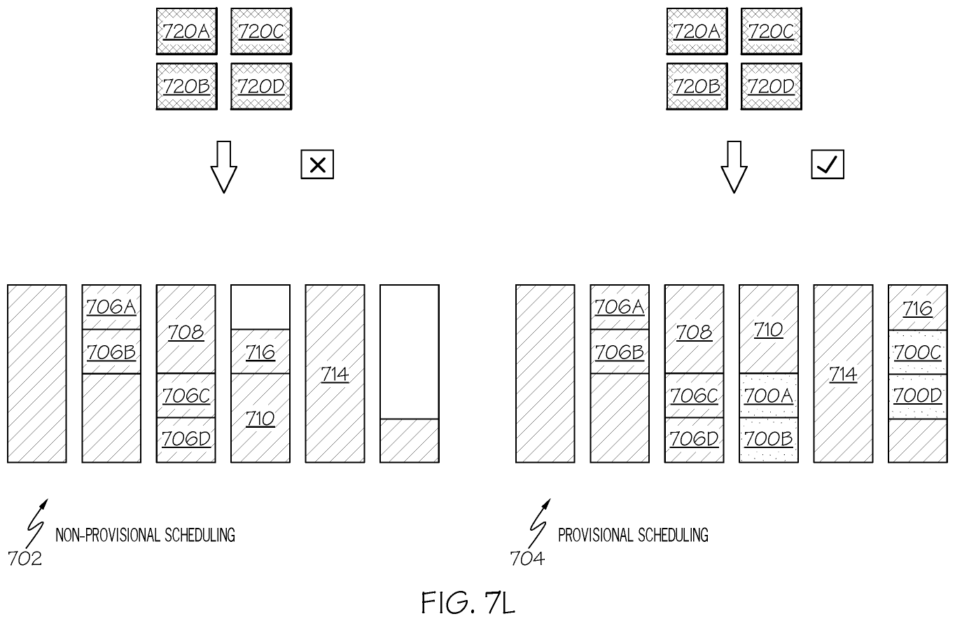

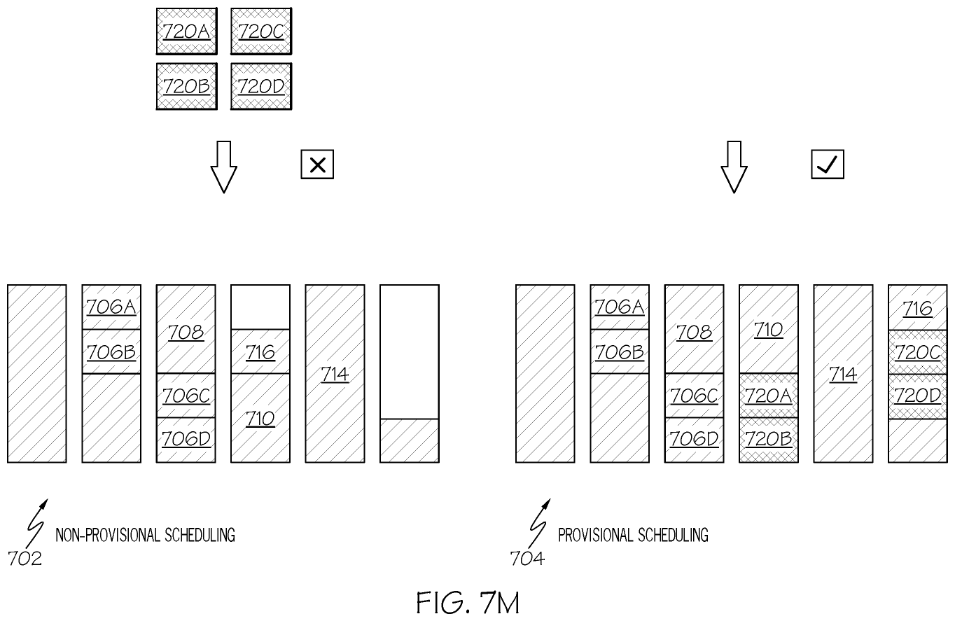

Referring now to FIG. 7A to 7M in connection with FIG. 4, state diagrams illustrating the operation of resource provisional scheduling engine 100 (shown in FIG. 4) are shown.

FIG. 7A depicts two racks of servers, one using non-provisional scheduling, hereinafter “server rack 702”, and the other using provisional scheduling, hereinafter “server rack 704”. Incoming group requests 706A-D to both server racks are also depicted. Additionally, server rack 704 receives incoming provisional group requests 700A-D for provisional scheduling.

FIG. 7B depicts the placement of the respective group requests in the two server racks. Provisional group requests 700A-D are only provisionally placed.

FIG. 7C depicts additional incoming group requests 708 to both server racks.

FIG. 7D depicts the placement of additional group requests 708 in the server racks.

FIG. 7E depicts further additional incoming group requests 710 to both server racks.

FIG. 7F depicts the placement of further additional group requests 710 in the server racks. On server racks 702, which are not using provisional scheduling, further additional group requests 710 may be assigned to any portion of the server racks having suitable resources. However, on server racks 704, which are using provisional scheduling, further additional group requests 710 are placed at a location on server rack 704 that permits those resources reserved for provisional group requests 700A-D to remain available.

FIG. 7G depicts completed group requests 712 departing the server racks, freeing those resources on which completed group requests 712 were running.

FIG. 7H depicts large additional incoming group requests 714 to both server racks.

FIG. 7I depicts the placement of large additional group requests 714 in the server racks, causing provisionally placed group requests 700C-D to be shifted to the recently freed resources on server racks 704 that also satisfy constraints of the shifted, provisionally placed group requests 700C-D.

FIG. 7J depicts small additional incoming group requests 716 to both server racks.

FIG. 7K depicts the placement of small additional group requests 716 in the server racks. On server racks 702, which are not using provisional scheduling, small additional group requests 716 may be assigned to any portion of server racks 702 having suitable resources. However, on server racks 704, which are using provisional scheduling, small additional group requests 716 are placed at a location on server rack 704 that permits those resources reserved for provisionally placed group requests 700A-D to remain available.

FIG. 7L depicts further additional incoming group requests 720A-D to both server racks. Further additional incoming group requests 720A-D are the actual requests corresponding to provisionally placed group requests 700A-D.

FIG. 7M depicts how further additional group requests 720A-D can be placed in server racks 704, which are using provisional scheduling, but that further additional group requests 720A-D cannot be placed in server racks 702, which are using non-provisional scheduling. This is due to successful placement of earlier incoming group requests relative to provisionally placed group requests 700A-D, allowing those resources provisionally allocated to remain available on server racks 704, in contrast to placement of earlier incoming requests on server rack 702 without consideration as to where future requests may need to be placed to avoid placement failure.

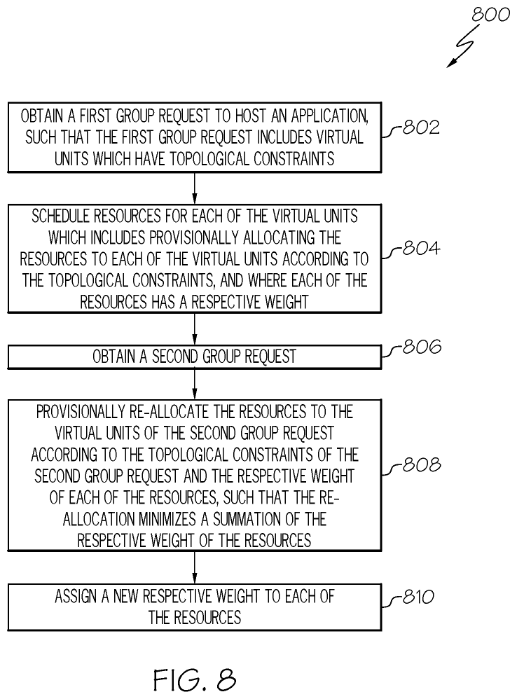

As depicted in FIG. 8, in one embodiment, a system (e.g., computer system/server 12) carries out the methodologies disclosed herein. Shown is a process flowchart 800 for provisionally scheduling resources in a cloud computing environment. At 802, a first group request to host an application is obtained, such that the first group request includes virtual units which have topological constraints. At 804, resources for each of the virtual units are scheduled which includes provisionally allocating the resources to each of the virtual units according to the topological constraints, and where each of the resources has a respective weight. At 806, a second group request is obtained. At 808, the resources are provisionally re-allocated to the virtual units of the second group request according to the topological constraints of the second group request and the respective weight of each of the resources, such that the re-allocation minimizes a summation of the respective weights of the resources. At 810, a new respective weight is assigned to each of the resources.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices, or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, program/utility 40 may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Any of the components provided herein can be deployed, managed, serviced, etc., by a service provider that offers to deploy or integrate computing infrastructure with respect to a process for provisionally scheduling resources in a cloud computing environment. Thus, embodiments herein disclose a process for supporting computer infrastructure, comprising integrating, hosting, maintaining, and deploying computer-readable code into a computing system (e.g., computer system/server 12), wherein the code in combination with the computing system is capable of performing the functions described herein.

In another embodiment, the invention provides a method that performs the process steps of the invention on a subscription, advertising, and/or fee basis. That is, a service provider, such as a Solution Integrator, can offer to create, maintain, support, etc., a process for provisionally scheduling resources in a cloud computing environment. In this case, the service provider can create, maintain, support, etc., a computer infrastructure that performs the process steps of the invention for one or more customers. In return, the service provider can receive payment from the customer(s) under a subscription and/or fee agreement, and/or the service provider can receive payment from the sale of advertising content to one or more third parties.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is apparent that there has been provided herein approaches to provisionally schedule resources in a cloud computing environment. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

What is claimed is:

1. A computer-implemented method for provisionally scheduling one or more resources in a cloud computing environment, comprising:
obtaining a first group request to host an application, wherein the first group request comprises one or more virtual units, and wherein each of the one or more virtual units comprise one or more topological constraints;
scheduling one or more resources for each of the one or more virtual units, wherein the scheduling comprises provisionally allocating the one or more resources to each of the one or more virtual units according to the one or more topological constraints, and wherein each of the one or more resources comprises a respective weight;
responsive to obtaining a second group request, provisionally re-allocating the one or more resources to one or more virtual units of the second group request according to one or more topological constraints of the second group request and the respective weight of each of the one or more resources, wherein the re-allocating minimizes a summation of each respective weight of the one or more resources; and
assigning a new respective weight to each of the one or more resources.

2. The method of claim 1, further comprising:
responsive to obtaining an invocation request for a virtual unit, allocating to the virtual unit the one or more resources that are provisionally allocated to the virtual unit.

3. The method of claim 2, further comprising:
responsive to a placement failure of the first group request, re-allocating the one or more resources that are allocated to the one or more virtual units of the first group request, wherein the one or more topological constraints of the first group request and the second group request are met.

4. The method of claim 1, further comprising:
provisionally re-allocating one or more resources that are allocated to an uninvoked first virtual unit to a second virtual unit, wherein one or more topological constraints of one or more group requests with which the first virtual unit and the second virtual unit are associated are met, and wherein the re-allocating is performed periodically.

5. The method of claim 4, wherein the one or more topological constraints comprise at least one of the following: resource location, resource cost, resource availability, resource power consumption, resource network bandwidth, resource latency, and resource storage quota.

6. The method of claim 1, wherein a respective weight is calculated based upon at least one of the following: uniformity of resources requested by an application, nature of tasks performed by an application, application user type, application user group, application priority, application resource consumption, application duration of execution, application execution constraints, application complexity, time of day of application execution, geography in which application is executed, adherence to application service level agreements (SLAs) and incentives, phase of application execution, and application resource consumption elasticity.

7. The method of claim 6, wherein a resource of the one or more resources having an assigned respective weight of zero (0) indicates that the resource is available for allocation, wherein a resource of the one or more resources having an assigned respective weight between zero (0) and one (1) indicates that the resource is provisionally allocated, wherein a resource of the one or more resources having an assigned respective weight of one (1) indicates that the resource is already allocated, and wherein a first resource of the one or more resources having a greater assigned respective weight than a second resource of the one or more resources indicates that the first resource has a lower priority for re-allocation than the second resource.

8. A computer system for provisionally scheduling one or more resources in a cloud computing environment, the computer system comprising:
a memory medium comprising program instructions;
a bus coupled to the memory medium; and
a processor, for executing the program instructions, coupled to provisional scheduler engine via the bus that when executing the program instructions causes the system to:
obtain a first group request to host an application, wherein the first group request comprises one or more virtual units, and wherein each of the one or more virtual units comprise one or more topological constraints;
schedule one or more resources for each of the one or more virtual units, wherein the scheduling comprises provisionally allocating the one or more resources to each of the one or more virtual units according to the one or more topological constraints, and wherein each of the one or more resources comprises a respective weight;
responsive to obtaining a second group request, provisionally re-allocate the one or more resources to one or more virtual units of the second group request according to one or more topological constraints of the second group request and the respective weight of each of the one or more resources, wherein the re-allocating minimizes a summation of each respective weight of the one or more resources; and
assign a new respective weight to each of the one or more resources.

9. The computer system of claim 8, the instructions further causing the system to:
responsive to obtaining an invocation request for a virtual unit, allocate to the virtual unit the one or more resources that are provisionally allocated to the virtual unit.

10. The computer system of claim 9, the instructions further causing the system to:
responsive to a placement failure of the first group request, re-allocate the one or more resources that are allocated to the one or more virtual units of the first group request, wherein the one or more topological constraints of the first group request and the second group request are met.

11. The computer system of claim 8, the instructions further causing the system to:
provisionally re-allocate one or more resources that are allocated to an uninvoked first virtual unit to a second virtual unit, wherein one or more topological constraints of one or more group requests with which the first virtual unit and the second virtual unit are associated are met, and wherein the re-allocating is performed periodically.

12. The computer system of claim 11, wherein the one or more topological constraints comprise at least one of the following: resource location, resource cost, resource availability, resource power consumption, resource network bandwidth, resource latency, and resource storage quota.

13. The computer system of claim 8, wherein a respective weight is calculated based upon at least one of the following: uniformity of resources requested by an application, nature of tasks performed by an application, application user type, application user group, application priority, application resource consumption, application duration of execution, application execution constraints, application complexity, time of day of application execution, geography in which application is executed, adherence to application service level agreements (SLAs) and incentives, phase of application execution, and application resource consumption elasticity.

14. The computer system of claim 13, wherein a resource of the one or more resources having an assigned respective weight of zero (0) indicates that the resource is available for allocation, wherein a resource of the one or more resources having an assigned respective weight between zero (0) and one (1) indicates that the resource is provisionally allocated, wherein a resource of the one or more resources having an assigned respective weight of one (1) indicates that the resource is already allocated, and wherein a first resource of the one or more resources having a greater assigned respective weight than a second resource of the one or more resources indicates that the first resource has a lower priority for re-allocation than the second resource.

15. A computer program product for provisionally scheduling one or more resources in a cloud computing environment, the computer program product comprising a computer readable hardware storage device, and program instructions stored on the computer readable hardware storage device, to:
obtain a first group request to host an application, wherein the first group request comprises one or more virtual units, and wherein each of the one or more virtual units comprise one or more topological constraints;
schedule one or more resources for each of the one or more virtual units, wherein the scheduling comprises provisionally allocating the one or more resources to each of the one or more virtual units according to the one or more topological constraints, and wherein each of the one or more resources comprises a respective weight;
responsive to obtaining a second group request, provisionally re-allocate the one or more resources to one or more virtual units of the second group request according to one or more topological constraints of the second group request and the respective weight of each of the one or more resources, wherein the re-allocating minimizes a summation of each respective weight of the one or more resources; and
assign a new respective weight to each of the one or more resources.

16. The computer program product of claim 15, the computer readable hardware storage device further comprising instructions to:
responsive to obtaining an invocation request for a virtual unit, allocate to the virtual unit the one or more resources that are provisionally allocated to the virtual unit.

17. The computer program product of claim 16, the computer readable hardware storage device further comprising instructions to:
responsive to a placement failure of the first group request, re-allocate the one or more resources that are allocated to the one or more virtual units of the first group request, wherein the one or more topological constraints of the first group request and the second group request are met.

18. The computer program product of claim 15, the computer readable hardware storage device further comprising instructions to:
provisionally re-allocate one or more resources that are allocated to an uninvoked first virtual unit to a second virtual unit, wherein one or more topological constraints of one or more group requests with which the first virtual unit and the second virtual unit are associated are met, and wherein the re-allocating is performed periodically,
wherein the one or more topological constraints comprise at least one of the following: resource location, resource cost, resource availability, resource power consumption, resource network bandwidth, resource latency, and resource storage quota.

19. The computer program product of claim 15, wherein a respective weight is calculated based upon at least one of the following: uniformity of resources requested by an application, nature of tasks performed by an application, application user type, application user group, application priority, application resource consumption, application duration of execution, application execution constraints, application complexity, time of day of application execution, geography in which application is executed, adherence to application service level agreements (SLAs) and incentives, phase of application execution, and application resource consumption elasticity.

20. The computer program product of claim 19, wherein a resource of the one or more resources having an assigned respective weight of zero (0) indicates that the resource is available for allocation, wherein a resource of the one or more resources having an assigned respective weight between zero (0) and one (1) indicates that the resource is provisionally allocated, wherein a resource of the one or more resources having an assigned respective weight of one (1) indicates that the resource is already allocated, and wherein a first resource of the one or more resources having a greater assigned respective weight than a second resource of the one or more resources indicates that the first resource has a lower priority for re-allocation than the second resource.
